(19) United States
(12) Patent Application Publication
(10) Pub. No.: US 2022/0317281 A1
(43) Pub. Date: Oct. 6, 2022

(54) SELF-LOCATION ESTIMATION DEVICE, METHOD, AND STORAGE MEDIUM

(71) Applicant: DENSO CORPORATION, Kariya-city (JP)

(72) Inventors: Itsuki CHIBA, Kariya-city. (JP); Makoto OHKADO, Kariya-city. (JP); Ariya TERANI, Kariya-city. (JP); Naohiro FUJIWARA, Kariya-city. (JP)

(21) Appl. No.: 17/808,267

(22) Filed: Jun. 22, 2022

Related U.S. Application Data
(63) Continuation of application No. PCT/JP2020/037089, filed on Sep. 30, 2020.

(30) Foreign Application Priority Data
Dec. 23, 2019 (JP) 2019-231734

(51) Int. Cl. G01S 13/86; G01S 13/58; G01S 13/06; G06T 7/70

(52) U.S. Cl. CPC G01S 13/867; G01S 13/58; G01S 13/06; G06T 7/70; G06T 2207/30252

(57) ABSTRACT

A self-location estimation device includes a landmark detection unit that detects a landmark from camera information, an association unit that associates the landmark detected by the landmark detection unit with a radar information group, a landmark sorting unit that performs sorting of the landmarks detected by the landmark detection unit based on the radar information groups associated with the landmarks by the association unit, and a positional relation calculation unit that calculates a positional relation between an own vehicle and the landmark employed by the landmark sorting unit, based on the radar information group associated with the landmark.

### CROSS-REFERENCE TO RELATED APPLICATION

The present application is based on and claims the benefit of priority from earlier Japanese Patent Application No. 2019-231734 filed Dec. 23, 2019, the description of which is incorporated herein by reference.

### BACKGROUND

### Technical Field

The present disclosure relates to a self-location estimation device, method, and storage medium that estimate a self-location of an own vehicle.

### Related Art

Self-location estimation devices are used which estimate a self-location of an own vehicle by using camera information such as camera images.

### SUMMARY

An aspect of the present disclosure is a self-location estimation device including: a landmark detection unit that detects a landmark from camera information; an association unit that associates the landmark detected by the landmark detection unit with a radar information group; a landmark sorting unit that performs sorting of the landmarks detected by the landmark detection unit based on the radar information groups associated with the landmarks by the association unit; and a positional relation calculation unit that calculates a positional relation between an own vehicle and the landmark employed by the landmark sorting unit, based on the radar information group associated with the landmark.

### BRIEF DESCRIPTION OF THE DRAWINGS

In the accompanying drawings:

FIG. 1 is a plan view illustrating a vehicle of an embodiment of the present disclosure;

FIG. 2 is a block diagram illustrating a self-location estimation system of the embodiment of the present disclosure;

FIG. 3 is a flowchart of a self-location estimation method of the embodiment of the present disclosure;

FIG. 4 is a schematic diagram illustrating an association step of the embodiment of the present disclosure;

FIG. 5 is a schematic diagram illustrating a landmark filtering step of the embodiment of the present disclosure; and

FIG. 6 is a schematic diagram illustrating a radar information filtering step of the embodiment of the present disclosure.

### DETAILED DESCRIPTION OF THE PREFERRED EMBODIMENTS

Self-location estimation devices are used which estimate a self-location of an own vehicle by using camera information such as camera images (for example, refer to US Patent Application Publication No. US2018/0024562A1). Such a self-location estimation device detects a landmark based the camera information to calculate a positional relation between the detected landmark and the own vehicle and to perform matching between the detected landmark and a landmark on map information. Then, the self-location estimation device estimates a self-location of the own vehicle on a map based on the calculated positional relation between the landmark and the own vehicle and the landmark on the map information subjected to the matching.

Detailed studies by the inventor found a problem that when detection of a landmark is performed based on camera information, the landmark may be erroneously detected, which lowers reliability of self-location estimation.

An object of the present disclosure is to provide a self-location estimation device, method, and storage medium that can remove an erroneously detected landmark to improve reliability of self-location estimation.

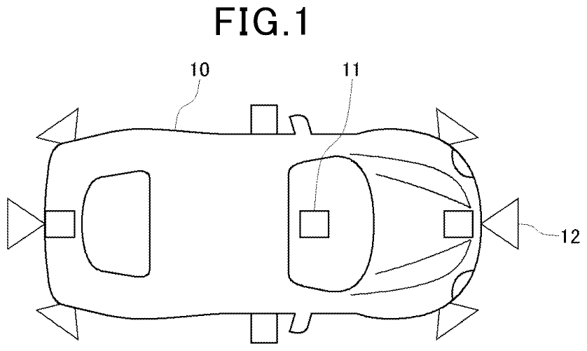

An embodiment of the present disclosure will be described with reference to FIG. 1 to FIG. 6.

In a self-location estimation system and method of the present embodiment, in self-location estimation, which estimates a location of an own vehicle on a map, if it is determined that a landmark detected from camera information is dynamic based on radar information associated with the landmark, the landmark is not employed and is removed. Furthermore, concerning each piece of radar information of a radar information group associated with the landmark, if it is determined that a radar observation point corresponding to the radar information is a dynamic observation point based on the radar information, the radar information is not employed and is removed.

With reference to FIG. 1, a vehicle 10 of the self-location estimation system will be described.

As illustrated in FIG. 1, a plurality of cameras 11 for acquiring camera information such as camera images are disposed at the vehicle 10. In addition, a plurality of radars 12 for acquiring a radar information group are disposed at the vehicle 10. As the radars 12, millimeter-wave radars or the like are used. As the radar information, a distance, a direction, a relative velocity and the like of radar observation points, which correspond to the radar information, with respect to the own vehicle are used. The radar information group may include a case in which the number of radar observation points is one and the number of pieces of radar information is one.

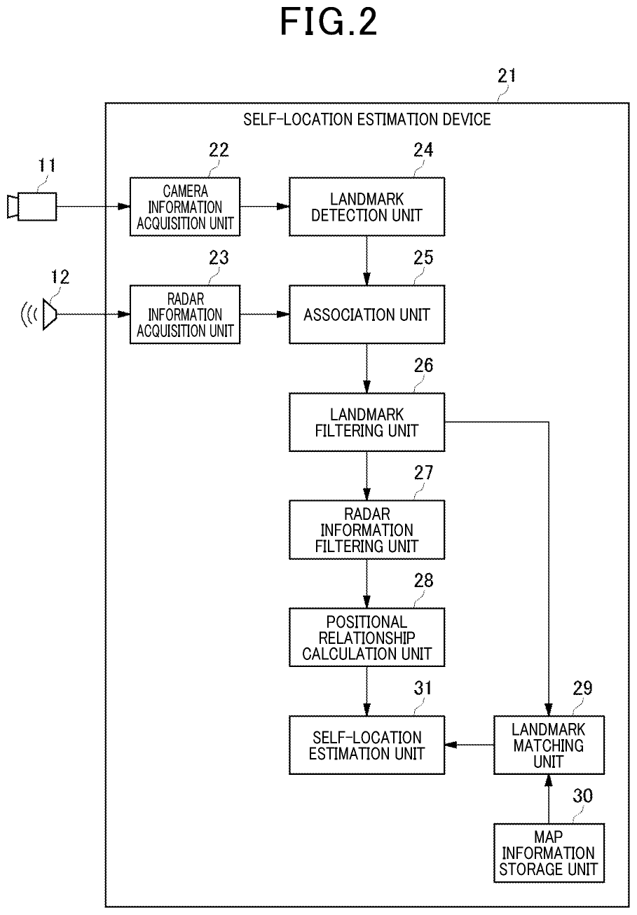

With reference to FIG. 2, a self-location estimation device 21 of the self-location estimation system will be described.

In the self-location estimation device 21, a camera information acquisition unit 22 acquires camera information from the cameras 11. A landmark detection unit 24 detects a landmark from the camera information acquired by the camera information acquisition unit 22. A radar information acquisition unit 23 acquires a radar information group from the radars 12. An association unit 25 associates the landmark detected by the landmark detection unit 24 with the radar information group acquired by the radar information acquisition unit 23.

A landmark filtering unit 26 performs sorting of the landmarks detected by the landmark detection unit 24 based on the radar information groups associated with the landmarks by the association unit 25. In the present embodiment, if determining that the landmark detected by the landmark detection unit 24 is dynamic based on the radar information group associated with the landmark by the association unit 25, the landmark filtering unit 26 does not employ the landmark and removes the landmark. If determining that the landmark is not dynamic but static, the landmark filtering unit 26 employs the landmark.

A radar information filtering unit 27 performs sorting of the radar information group associated with the landmark, which are employed by the landmark filtering unit 26, by the association unit 25, based on the radar information group. In the present embodiment, concerning each piece of radar information of the radar information group associated with the landmark, which is employed by the landmark filtering unit 26, by the association unit 25, if determining that the radar observation point corresponding to the radar information is a dynamic observation point based on the radar information, the radar information filtering unit 27 does not employ the radar information and removes the radar information. If determining that the radar observation point is not a dynamic observation point but a static observation point, the radar information filtering unit 27 employs the radar information.

Concerning the landmark employed by the landmark filtering unit 26, the positional relation calculation unit 28 calculates a positional relation between the landmark and the own vehicle based on the radar information group employed by the radar information filtering unit 27. In contrast, a landmark matching unit 29 acquires map information from a map information storage unit 30 and performs matching between the landmark employed by the landmark filtering unit 26 and the landmark on the map information. A self-location estimation unit 31 estimates a self-location of the own vehicle on the map based on the positional relation between the landmark and the own vehicle calculated by the positional relation calculation unit 28 and the landmark on the map information subjected to the matching by the landmark matching unit 29.

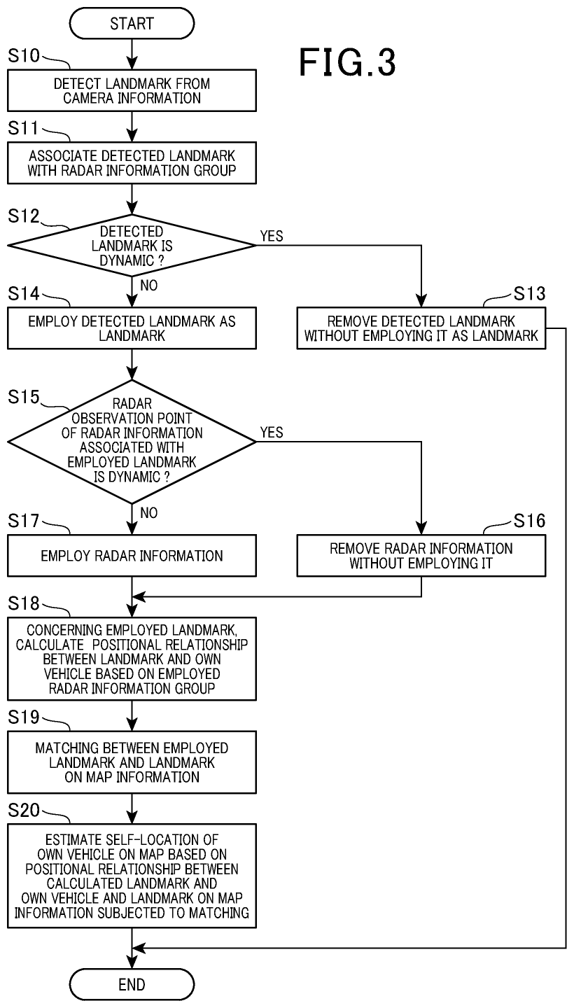

With reference to FIG. 3 to FIG. 6, a self-location estimation method of the present embodiment will be described.

As illustrated in FIG. 3, the self-location estimation method of the present embodiment executes the following steps.

Landmark Detection Step S10

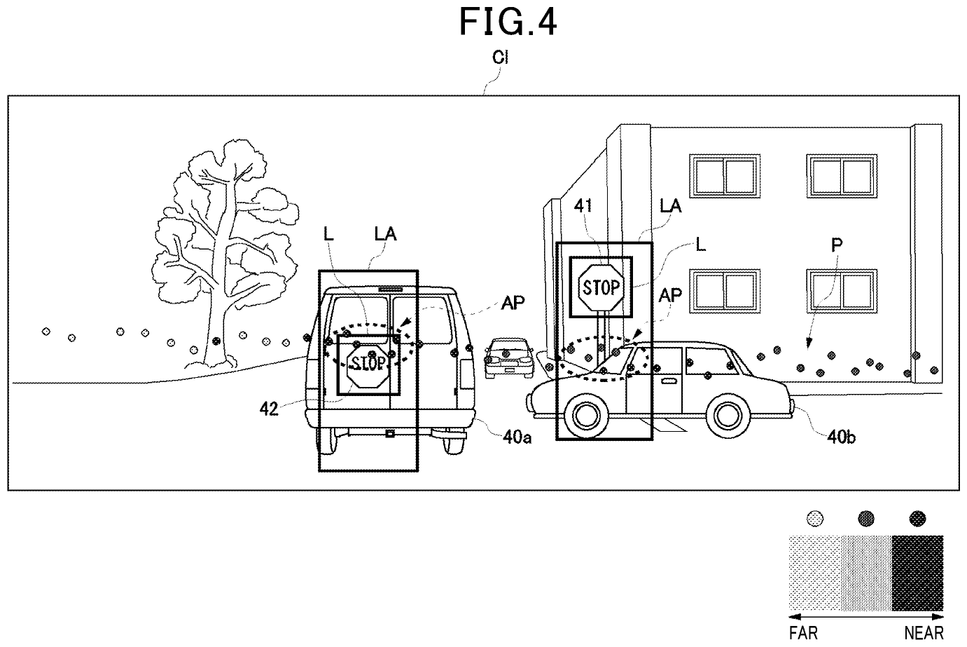

In landmark detection step S10, with reference to FIG. 4, a landmark L is detected from camera information CI such as came images. As a method of detecting a landmark, appropriate machine learning such as deep learning is used.

Association Step S11

In association step S11, the landmark detected in landmark detection step S10 is associated with a radar information group.

In the present embodiment, with reference to FIG. 4, concerning the landmarks L detected from camera information CI, the camera information CI is three-dimensionally converted to calculate locations at which the landmarks L are present in three-dimensional space. In addition, in consideration of errors due to the resolution of the camera 11 or the three-dimensional conversion of the camera information CI, landmark areas LA are set in which the landmark L may be present in three-dimensional space. On the other hand, concerning each piece of radar information of the radar information group, a location at which a radar observation point P is present in three-dimensional space is calculated based on a distance and a direction of the radar observation point P, which correspond to the radar information, with respect to the own vehicle. Then, in three-dimensional space, concerning a radar observation point AP included in the landmark area LA of a predetermined landmark L, the landmark L is associated with the radar information corresponding to the radar observation point AP.

Landmark Filtering Steps S12-S14

When a landmark is detected from camera information, an object that is not a landmark but has an appearance similar to that of a landmark may be erroneously detected as a landmark. Such an erroneously detected landmark is required to be removed.

Hence, in landmark filtering steps S12-S14, sorting of the landmarks detected in landmark detection step S10 is performed based on the radar information groups associated with the landmarks in association step S11.

Specifically, since landmarks are stationary objects on a map and are not moving objects, when a detected landmark is dynamic, the landmark can be assumed to be erroneously detected. Hence, the detected landmark should be removed without being employed.

Hence, in landmark filtering steps S12-S14, it is determined whether the landmark detected in landmark detection step S10 is dynamic based on the radar information group associated with the landmark in association step S11 (S12). If it is determined that the landmark detected in landmark detection step S10 is dynamic, the landmark is not employed as a landmark and is removed, and the self-location estimation method is ended (S13). In contrast, if it is determined that the landmark detected in landmark detection step S10 is not dynamic but static, the landmark is employed as a landmark (S14).

In the present embodiment, concerning all pieces of radar information of a radar information group associated with a landmark, if a velocity v (=|v+μ|) of a radar observation point, which corresponds to the radar information, calculated based on a relative velocity v of the radar observation point with respect to the own vehicle and a velocity μ of the own vehicle is a predetermined threshold value α (=a positive constant in the vicinity of 0) or more, it is determined that the landmark is dynamic, and the landmark is not employed as a landmark and is removed. In contrast, if it is determined that the velocity v is not the predetermined threshold value α or more, it is determined that the landmark is not dynamic but static, and the landmark is employed as a landmark.

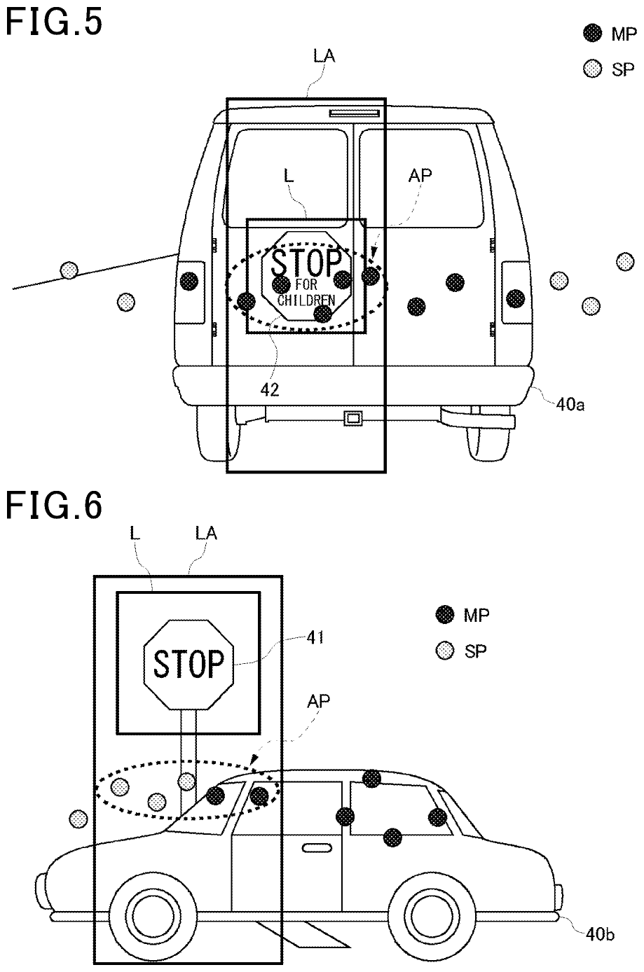

For example, as illustrated in FIG. 5, when a sticker 42 having an appearance similar to that of a traffic sign 41 is affixed to an other vehicle 40a, if the landmark L is detected from the camera information CI, the sticker 42 is likely to be erroneously detected as the landmark L. However, if the other vehicle 40a is traveling, concerning all pieces of radar information of the radar information group associated with the sticker 42, since a velocity v of the radar observation point AP corresponding to the radar information is the predetermined threshold value α or more, it is determined that the sticker 42 is dynamic, and the sticker 42 cannot be employed as the landmark L and can be removed. In contrast, as illustrated in FIG. 6, if the traffic sign 41 is detected as the landmark L from the camera information CI, concerning all pieces of radar information of the radar information group associated with the traffic sign 41, since the velocity v of the radar observation point AP corresponding to the radar information is not the predetermined threshold value α or more, it is determined that the traffic sign 41 is not dynamic but static, and the traffic sign 41 can be employed as the landmark L.

Radar Information Filtering Steps S15-S17

Since some radar information groups associated with landmarks are likely to include radar information on an observed object other than the landmark, the radar information should be removed without being employed.

Hence, in radar information filtering steps S15-S17, sorting of the radar information group associated with the landmark employed in landmark filtering steps S12-S14 is performed based on the radar information group.

Specifically, as described above, since landmarks are stationary objects on a map and are not moving objects, when a radar observation point corresponding to radar information is a dynamic observation point, the radar information can be assumed not to be obtained by observing a landmark. Hence the radar information should be removed without being employed.

Hence, in radar information filtering steps S15-S17, concerning each piece of radar information of the radar information group associated with the landmark, which is employed in landmark filtering steps S12-S14, in association step S11, it is determined whether the radar observation point corresponding to the radar information is a dynamic observation point (S15). If it is determined that the radar observation point corresponding to the radar information is a dynamic observation point, the radar information is removed without being employed (S16). In contrast, if it is determined that the radar observation point corresponding to the radar information is not a dynamic observation point but a static observation point, the radar information is employed (S17). In the flowchart in FIG. 3, sorting of all pieces of radar information of the radar information group associated with the landmark is not shown.

In the present embodiment, concerning each piece of radar information of a radar information group associated with a landmark, if a velocity v (=|v+μ|) of a radar observation point, which corresponds to the radar information, calculated based on a relative velocity v of a radar observation point with respect to the own vehicle and a velocity μ of the own vehicle is a predetermined threshold value α (=a positive constant in the vicinity of 0) or more, it is determined that the radar observation point is a dynamic observation point, and the radar information is not employed and is removed. In contrast, if it is determined that the velocity v of the radar observation point is not the predetermined threshold value α or more, it is determined that the radar observation point is not a dynamic observation point but a static observation point, and the radar information is employed.

For example, as illustrated in FIG. 6, even when the detected and employed landmark L is the traffic sign 41, the radar information group associated with the traffic sign 41 may include radar information obtained by observing an other vehicle 40b in the vicinity of the traffic sign 41. However, if the other vehicle 40b is traveling, concerning the radar observation point AP obtained by observing the other vehicle 40b, since the velocity v of the radar observation point AP is the predetermined threshold value α or more, it is determined that the radar observation point AP is a dynamic observation point MP, and the radar information corresponding to the dynamic observation point MP cannot be employed and can be removed. In contrast, since the velocity v of the radar observation point AP obtained by observing the traffic sign 41 is not the predetermined threshold value α or more, it is determined that the radar observation point AP is not the dynamic observation point MP but a static observation point SP, and the radar information corresponding to the static observation point SP can be employed.

Positional Relation Calculation Step S18

In positional relation calculation step S18, concerning the landmark employed in landmark filtering steps S12-S14, a positional relation between the landmark and the own vehicle is calculated based on the radar information group employed in radar information filtering steps S15-S17. In the present embodiment, an average value of distances from the own vehicle to radar observation points corresponding to all pieces of radar information included in the employed radar information group is determined to calculate a distance between the landmark and the own vehicle.

Landmark Matching Step S19

In landmark matching step S19, matching between the landmark employed in landmark filtering steps S12-S14 and the landmark on the map information is performed.

Self-Location Estimation Step S20

In self-location estimation step S20, a self-location of the own vehicle on the map is estimated based a positional relation between the landmark and the own vehicle calculated in positional relation calculation step S18 and the landmark on the map information subjected to the matching in landmark matching step S19.

The self-location estimation system and method of the present embodiment provide the following effects.

In the self-location estimation system and method of the present embodiment, sorting of landmarks detected from camera information is performed based on radar information associated with the landmarks. Hence, erroneously detected landmarks can be removed to improve reliability of self-location estimation. Specifically, although landmarks are stationary objects on a map and are not moving objects, if it is determined that a landmark detected from the camera information is dynamic, the landmark is not employed as a landmark and is removed. Hence, the erroneously detected landmark can be removed appropriately to improve reliability of the self-location estimation sufficiently.

In addition, sorting of the radar information group associated with a landmark is performed based on the radar information group. Hence, radar information obtained by observing objects other than landmarks can be removed to improve accuracy in self-location estimation. Specifically, as described above, since landmarks are stationary objects on a map and are not moving objects, if it is determined that a radar observation point corresponding to the radar information is a dynamic observation point, the radar information is not employed and is removed. Hence, the radar information obtained by observing objects other than landmarks can be removed appropriately to improve accuracy in self-location estimation sufficiently.

In the above embodiment, although a self-location estimation system and method has been described, a program causing a computer to achieve functions of the present system and a program causing a computer to perform the steps of the present method are also included in the scope of the present disclosure. A storage medium (for example, which is included in the self-location estimation device 21) in which the program (self-location estimation program) is stored is also included in the scope of the present disclosure.

The present disclosure has been described on the basis of the embodiment, but it is understood that the present disclosure is not limited to the embodiment, the structure, and the like. The present disclosure includes various modified examples and modifications within an equivalent range. In addition, a category and range of thought of the present disclosure include various combinations and forms and other combinations and forms including only one element, one or more elements, or one or less elements of those.

A first aspect of the present disclosure is a self-location estimation device (21), including: a landmark detection unit (24) that detects a landmark from camera information; an association unit (25) that associates the landmark detected by the landmark detection unit with a radar information group; a landmark sorting unit (26) that performs sorting of the landmarks detected by the landmark detection unit based on the radar information groups associated with the landmarks by the association unit; and a positional relation calculation unit (28) that calculates a positional relation between an own vehicle and the landmark employed by the landmark sorting unit, based on the radar information group associated with the landmark.

A second aspect of the present disclosure is a self-location estimation method, including the step of: detecting a landmark from camera information; associating the detected landmark with a radar information group; performing sorting of the detected landmarks based on the radar information groups associated with the landmarks; and calculating a positional relation between an own vehicle and the employed landmark based on the radar information group associated with the landmark.

A third aspect of the present disclosure is a storage medium in which a self-location estimation program is stored to cause a computer to execute processing, the processing including the function of: detecting a landmark from camera information; associating the detected landmark with a radar information group; performing sorting of the detected landmarks based on the radar information groups associated with the landmarks; and calculating a positional relation between an own vehicle and the employed landmark based on the radar information group associated with the landmark.

According to the present disclosure, an erroneously detected landmark can be removed to improve reliability of self-location estimation.

What is claimed is:

1. A self-location estimation device, comprising:
a landmark detection unit that selectively detects a landmark from objects indicated by camera information;
an association unit that associates the landmark detected by the landmark detection unit with a radar information group;
a landmark sorting unit that performs sorting of the landmarks detected by the landmark detection unit based on the radar information groups associated with the landmarks by the association unit, to remove the landmark erroneously detected by the landmark detection unit; and
a positional relation calculation unit that calculates a positional relation between an own vehicle and the landmark employed by the landmark sorting unit, based on the radar information group associated with the landmark.

2. The self-location estimation device according to claim 1, wherein
if determining that the landmark detected by the landmark detection unit is dynamic based on the radar information group associated with the landmark by the association unit, the landmark sorting unit does not employ the landmark.

3. The self-location estimation device according to claim 2, wherein
concerning all pieces of radar information associated with the landmark, which is detected by the landmark detection unit, by the association unit, if a velocity of a radar observation point corresponding to the radar information is a predetermined threshold value or more, it is determined that the landmark is dynamic.

4. A self-location estimation device, comprising:
a landmark detection unit that detects a landmark from camera information;
an association unit that associates the landmark detected by the landmark detection unit with a radar information group;
a landmark sorting unit that performs sorting of the landmarks detected by the landmark detection unit based on the radar information groups associated with the landmarks by the association unit;
a radar information sorting unit that performs sorting of the radar information group associated with the landmark, which is employed by the landmark sorting unit, by the association unit, based on the radar information group; and
a positional relation calculation unit that calculates a positional relation between an own vehicle and the landmark employed by the landmark sorting unit, based on the radar information group associated with the landmark.

5. The self-location estimation device according to claim 4, wherein
concerning radar information associated with the landmark, which is employed by the landmark sorting unit, by the association unit, if determining that a radar observation point corresponding to the radar information is a dynamic observation point, the radar information sorting unit does not employ the radar information.

6. The self-location estimation device according to claim 5, wherein
concerning the radar information associated with the landmark, which is employed by the landmark sorting unit, by the association unit, if determining that a velocity of the radar observation point corresponding to the radar information is a predetermined threshold value or more, the radar information sorting unit determines that the radar observation point is the dynamic observation point.

7. A self-location estimation method, comprising the step of:
selectively detecting a landmark from objects indicated by camera information;
associating the detected landmark with a radar information group;
performing sorting of the detected landmarks based on the radar information groups associated with the landmarks, to remove the erroneously detected landmark; and
calculating a positional relation between an own vehicle and the employed landmark based on the radar information group associated with the landmark.

8. A storage medium in which a self-location estimation program is stored to cause a computer to execute processing, the processing comprising the function of:
selectively detecting a landmark from objects indicated by camera information;
associating the detected landmark with a radar information group;
performing sorting of the detected landmarks based on the radar information groups associated with the landmarks, to remove the erroneously detected landmark; and
calculating a positional relation between an own vehicle and the employed landmark based on the radar information group associated with the landmark.
